(19) United States
(12) Patent Application Publication
(10) Pub. No.: US 2025/0322699 A1
(43) Pub. Date: Oct. 16, 2025

(54) METHOD FOR ANONYMISING VEHICLE DATA

(71) Applicant: MERCEDES-BENZ GROUP AG, Stuttgart (DE)

(72) Inventors: Alexander HANUSCHKIN, Karlsruhe (DE); Joana HOIS, Böblingen (DE); Stefan STUDER, Stuttgart (DE)

(21) Appl. No.: 18/866,185

(22) PCT Filed: Apr. 24, 2023
(86) PCT No.: PCT/EP2023/060611

§ 371 Date: Nov. 15, 2024

(30) Foreign Application Priority Data
May 17, 2022 (DE) 10 2022 001 720.2

(51) Int. Cl. G07C 5/04; G06F 21/62

(52) U.S. Cl. CPC G07C 5/04; G06F 21/6254

(57) ABSTRACT

Vehicle data for the use of vehicle-external services is anonymized. Within a fleet of vehicles of the same type with a diverse group of vehicle users, a first variable, which is at least indirectly dependent on an integer number n of recorded vehicle sensor values, and a second variable, which is at least indirectly dependent on an integer number m of current vehicle sensor values, is recorded for each of the vehicles. Similarities are determined for at least one of the variables of several or all vehicles in the fleet, after which the vehicles are then categorized into a class that is similar in terms of the similarity of the at least one variable or into a dissimilar class. If a vehicle-external service is requested, a computed variable from the corresponding variables of several vehicles from the class of the similar vehicles or an artificially generated similar variable is transmitted.

### BACKGROUND AND SUMMARY OF THE INVENTION

Exemplary embodiments of the invention relate to a method for anonymizing vehicle data for the use of vehicle-external services, as well as to a vehicle configured to use the method.

In today's vehicles, a large amount of data from vehicles in a vehicle fleet is exchanged cyclically with vehicle-external servers, for example those of a vehicle manufacturer or a fleet operator, or also with the servers of providers of vehicle-external services. Technical progress and the installation of vehicle sensor systems and vehicle interior sensor systems as standard, as well as the exchange of information captured by these sensor systems, means that people, their data and their statuses can be effectively monitored at vehicle-external locations. This data can contain personal data of the vehicle user or corresponding vehicle data, which allows conclusions to be drawn about the person using the vehicle. In particular, such data can be used to produce user profiles, to create a type of “fingerprint” of the respective vehicle or the like. Therefore, from a data protection point of view, this data needs protection to a greater or lesser extent. On the one hand, the people using the vehicle are worried about how their data will be used, but at the same time they also want to be able to continue to use existing services.

DE 10 2020 003 188 A1 describes a method for protecting personal data of a vehicle occupant, in which method emotional states of the vehicle occupant are recorded in the vehicle as personal data and the masked emotional states are analyzed in a vehicle-external device. They are then assigned to an emotions group containing a multiplicity of emotion patterns in order to then depersonalize the emotional state of the vehicle occupant for their protection.

DE 10 2021 001 378 B3, unpublished at the time of filing, describes a method for anonymizing movement data of road users provided with a position detection device. The primary objective here is to monitor the flow of traffic, while preventing data requiring protection from being included in the transmission but still providing sufficient data accuracy to ensure that the flow of traffic can be reliably analyzed.

DE 10 2015 213 393 A1 describes methods for anonymizing vehicle data for the use of vehicle-external services. Here, in addition to original vehicle data indicating road sections covered by a vehicle, further artificial vehicle data is generated, which indicates an artificial route. Original vehicle data and artificial vehicle data are stored or transmitted together.

DE 10 2015 226 650 A1 discloses a method for anonymized transmission of a first value of a driving parameter of a vehicle to an external data receiving unit. Further values for the driving parameter that are transmitted to the vehicle by other vehicles are then received from the vehicle. A second value for the driving parameter is calculated from the first value and the further values in such a way that the first value cannot be reconstructed by the external data receiving unit. The second value is transmitted to the external data receiving unit.

The problem addressed by the present invention consists, in particular, in providing an improved method for anonymizing vehicle data when using vehicle-external services.

The method according to the invention is used for anonymizing vehicle data for the use of vehicle-external services. It is taken as given that in a large fleet of identical vehicles and an associated large diverse group of vehicle users, there is a high probability that similar vehicle use profiles exist. Furthermore, vehicle-external services are used, in the course of which information is sent from the vehicles to the provider of the vehicle-external services.

Sensors installed in and on the vehicle continuously determine vehicle sensor values describing both the status of the vehicle (e.g., position, speed, distance driven, route information, age, etc.) and the status of the driver and passengers (e.g., level of alertness, driving style, etc.). According to the invention, within the fleet of vehicles of the same type with a diverse group of vehicle users, a first variable, which is at least indirectly dependent on an integer number n of recorded vehicle sensor values, and a second variable, which is at least indirectly dependent on an integer number m of current vehicle sensor values, are now recorded for each of the vehicles.

The two variables are therefore determined for each vehicle in the fleet. The first variable is a characteristic set of up to n vehicle sensor values and is determined from recorded vehicle sensor values. It is approximately constant over time (e.g., load collective data), so it can be called a static variable here. In a borderline case, the variable can also correspond directly to just one single sensor value. In addition, the second variable is a characteristic set of up to m vehicle sensor values. It is determined from the current vehicle sensor values and changes dynamically over time (e.g., position, speed, acceleration, etc.), so it can be called a dynamic variable here. This variable too can correspond directly to just one single sensor value in a borderline case.

The first variable, in particular if it is based on a plurality of vehicle sensor values, enables each vehicle to be identified like a fingerprint, since this variable is based on individual vehicle and usage behavior and varies very little over time. Therefore, these first variables are particularly in need of protection from a data protection perspective. The second variables, by contrast, reflect current, up-to-date data about the vehicle and the use thereof. It is only possible to identify the vehicle indirectly (for example through a combination of geolocation and local image information).

Similarities are now determined for the first variable of several or all vehicles in the fleet, after which the vehicles are then categorized into a class that is similar in terms of the similarity of the at least one variable or into a dissimilar class. More particularly, it is possible to determine vehicles with similar vehicle sensor values in the first and/or second variable. A preferred embodiment of the invention uses machine learning clustering mechanisms for this purpose (e.g., k-means, mean shift or expectation maximization (EM) clustering), in order to generate a similarity measure for the first and/or the second variable. Here, at least the similarities in the second variable are determined continuously, since this changes in the fleet over time.

Now, if a vehicle-external service is requested, instead of the variable of the requesting vehicle that contains the information relevant to the service, the corresponding variable of a vehicle from the class of the similar vehicles, a computed variable from the corresponding variables of several vehicles from the class of the similar vehicles or an artificially generated similar variable is transmitted.

This creates a privacy layer, which, in the simplest case, uses sufficiently similar information from another vehicle in the fleet for the corresponding vehicle-external service instead of the real information of the vehicle. In a further embodiment, relevant information can be determined, for example by averaging, or artificially generated via a group containing relevant information from similar vehicles.

When a first vehicle calls up a vehicle-external service, information relevant to this service is transmitted from the variables of similar vehicles data ascertained from the variables thereof (e.g., by averaging) or artificially generated data.

In addition, typically not all of the information sent to the provider of the vehicle-external service is required in order to provide the service, but rather a lot of information that is irrelevant to the service is transmitted to the provider of the vehicle-external service, so that this additional information can be monetized as added value by the provider of the vehicle-external service. Typically, this information is based on the respective other variable. According to a very advantageous refinement of the method according to the invention, it can therefore be provided that instead of this other variable of the requesting vehicle, the corresponding variable of a vehicle from the class of the dissimilar vehicles, a computed variable from the corresponding variables of several vehicles from the class of the dissimilar vehicles or an artificially generated similar variable is transmitted.

A privacy layer is thus achieved, which replaces the information of the vehicle with information relevant to the vehicle-external service from similar vehicles and irrelevant information from dissimilar vehicles and thus conceals the actual information of the vehicle that is worth protecting.

The artificially generated variable, which is possible in both cases but is especially important for the less relevant information, can according to an advantageous embodiment of the invention be generated via generative machine learning methods.

Models can be trained for this purpose that are optimized to generate the most “realistic” variables possible, which can then be used for random, in particular second, variables. This “realism” is achieved by using suitable functions, which are defined either generically or depending on the services that the vehicle would like to use. It is thereby also possible to focus on the content of the n, or in particular m, vehicle sensor values.

The variables that are at least indirectly dependent on an integer number of vehicle sensor values, i.e., the first variable and the second variable, can, according to a very advantageous embodiment of the method according to the invention, be formed as a set of the n or m vehicle sensor values. The variable therefore consists of a corresponding set or, if a specific arrangement of the sensor values in a predefined sequence is desired, also of an n-tuple or m-tuple.

An alternative embodiment of the respective variable can provide that the respective variable is formed in the n- or m-dimensional space as a vector based on the respective vehicle sensor values.

Therefore, two vectors are determined for each vehicle in the fleet, the first variable being a characteristic n-dimensional vector that is determined from the recorded vehicle sensor values. The second vector corresponding to the second variable would then be an m-dimensional vector, which is determined from the current vehicle sensor values.

In particular, the first vector enables very simple identification of each vector, like a fingerprint, and is thus particularly worthy of protection. The second vector essentially reflects up-to-date values of the vehicle during use and is less worthy of protection here in terms of data protection.

According to another very favorable embodiment of the method according to the invention, the two variables, as a development of their embodiment as vectors, can also be realized in such a way that the respective variable is formed as a transformation of the respective vector to a value with a smaller number or at most the same number of dimensions. The transformation can preferably be a spatial dimension reduction. A corresponding value with n′ or m′ dimensions can be generated from the vector with the n or m dimensions by means of a suitable transformation such as a principal component analysis (PCA), or also via a transformation using a deep neural network. The number of dimensions preferably decreases in this case or is at most the same as the number of previous dimensions, i.e., it never increases. Because the vector with n or m dimensions is now transformed into a space with n′ or m′ dimensions respectively, it is compressed and encrypted in a certain way, so that it is no longer possible to directly draw conclusions from this new value about the previous vector or the vehicle sensor values on which this vector is based. If the providers of vehicle-external services are therefore able to process such vectors or, preferably, transformed values generated from the vectors in order to provide their services, a certain degree of anonymization can already be achieved here just by doing this. If this is additionally combined with the above-described “privacy layer” function, then very good data protection is achieved by transmitting relevant similar and, where necessary, less relevant dissimilar information.

According to a very favorable embodiment of the method according to the invention, it can now also be provided that machine learning clustering mechanisms are used to determine the classes of similar and dissimilar variables in order to determine a similarity measure, wherein the variables are classified on the basis of a default value and a comparison of the ascertained similarity measure with this default value. This advantageous embodiment of the method according to the invention therefore uses machine learning clustering mechanisms. These can include k-means, mean shift or expectation maximization (EM) clustering, for example. Such mechanisms can then be used to generate a similarity measure for the first variable and/or the second variable, for example as a vector or transformation of the respective vector. Based on a default value, the determined similarity measure can then be classified using this default value. If the similarity measure is, for example, between 0 and 100 per cent, a default value of, for example, 80% can be used to differentiate between dissimilar information, which is then between 0 and 80% or sufficiently similar information between 80 and 100%.

According to a very advantageous embodiment of the method according to the invention, the default value can vary depending on the vehicle-external service. The data of the relevant vehicle sensor or also the absolute value thereof, for example, offer other options for varying or parameterizing the value, since similarities used at low speeds, for example, can be different to those used at correspondingly fast speeds. An example here could be a weather app, which only requires a relatively low degree of similarity with regard to the exact position, so that determining the position to within a few kilometers or hundred meters is more than sufficient. If, however, the vehicle-external service is a navigation system, such an indication of the position would of course not be sufficient and a much higher degree of similarity between the values is required here.

A further very favorable variant of the method according to the invention provides that the variables are at least partially exchanged between the vehicles and a central data center, wherein the information is aggregated and analyzed in the central data center. Information from and about vehicles in the fleet can therefore be exchanged via a data center, in particular a cloud, and the information can be aggregated and analyzed in the data center/cloud. Alternatively, or additionally thereto, it can also be provided according to the invention that the variables are at least partially exchanged, aggregated, and analyzed between the vehicles in the fleet. In this second approach, information can be aggregated and analyzed in a decentralized way in the vehicle fleet by the exchange of information between the vehicles in the fleet. It is advantageously possible here for the vehicles to communicate directly with other vehicles in the vicinity in a decentralized way, in particular with vehicles with similar dynamic values (i.e., with vehicles having similar current values (e.g., position, speed, acceleration, etc.), since they are travelling to the same place, e.g., in the same direction).

Whereas the first solution reduces data transfer times and latencies, decentral information processing can increase data security (since no central location stores all of the information about the fleet) and is robust against the failure of individual nodes, in particular the central node. The two solutions can also be combined so that the method acts partly in a centralized way and partly in decentralized way.

According to a very advantageous embodiment of the idea, in order to distinguish between information that is relevant and information that is less relevant to the vehicle-external service, information with a similar first variable and information with a respectively dissimilar second variable can be sent from at least some of the vehicles in the fleet to the vehicle-external service, after which the service is then analyzed. The vehicle fleet is thus used to test vehicle-external services to determine which information is relevant for the results of the service (profiling). For this purpose, a plurality of orchestrated queries with first and second variables are sent to the provider of the vehicle-external services, which cover the possible value range of the query. The responses to the queries transmitted by the provider of the vehicle-external services are analyzed in the data center/cloud and/or in the fleet for similarity.

For this purpose, first, a group of vehicles from the fleet sends queries to the provider of the vehicle-external services, which have similar data in one of the two variables but different data in the respective other variable. It is thus possible to ascertain whether one of the variables alone is sufficient to use the vehicle-external service.

A very advantageous embodiment of this method provides that individual vehicle sensor values are then logged and other vehicle sensor values are randomized in order to determine relevant and less relevant vehicle sensor values for the use of the respective vehicle-external service. Building on the above-described query, individual data or data groups from the variables are now logged and the remaining data is randomized during the query in order to arrive at a final group of information relevant to the vehicle-external service. It is therefore also possible to utilize value ranges that are as far away as possible from the respective variable owing to the “privacy layer”.

The method according to the invention is therefore in particular suitable for use in vehicles in a vehicle fleet of essentially the same type of vehicles, for example a fleet of privately used passenger cars, passenger cars used as company cars, vehicles belonging to a brand or a group of brands, commercial vehicles or the like. The vehicle according to the invention is equipped with a plurality of sensors and at least one communication interface, which is set up to perform the method together with other vehicles and/or an external data center.

### BRIEF DESCRIPTION OF THE DRAWING FIGURES

Further advantageous embodiments of the method according to the invention and of vehicles set up to perform the method according to the invention are also found in the exemplary embodiment, which is described in detail hereinafter with reference to the figures, in which:

FIG. 1 shows a basic use scenario for the method according to the invention;

FIG. 2 shows an exemplary two-dimensional representation of vehicle information;

FIG. 3 shows an exemplary one-dimensional compression of the representation from FIG. 2;

FIG. 4 shows a first possible embodiment for realizing the method according to the invention; and

FIG. 5 shows a second possible embodiment for realizing the method according to the invention.

### DETAILED DESCRIPTION

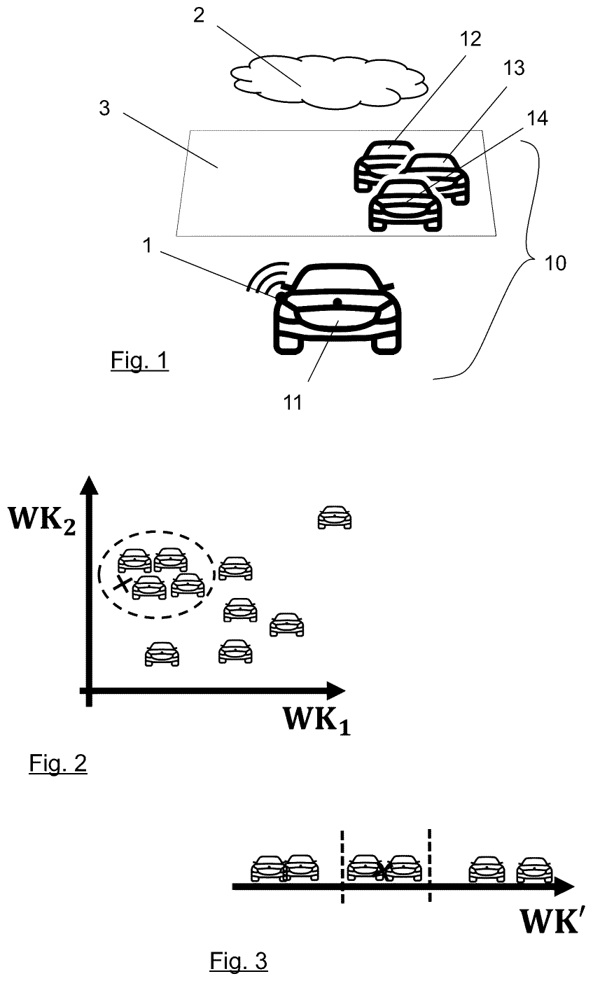

FIG. 1 shows a first vehicle 11 having a plurality of sensors (not illustrated) and a communication interface 1, via which a communication link can be established with a cloud, labelled 2, via which a provider of vehicle-external services FES provides their services. Between the vehicle 11 and the cloud 2 of the provider of the FES, there is a privacy layer, labelled 3, in which the vehicle data for the use of the FES by the vehicle 11 is anonymized. Vehicle data from other vehicles labelled 12, 13, 14 in a fleet 10 of vehicles 11, 12, 13, 14 of the same type with a diverse group of vehicle users is used for this purpose.

In such a fleet 10 of vehicles 11, 12, 13, 14 of the same type and an associated large diverse group of vehicle users, there is a very high probability that similar vehicle data exists in the form of use profiles. This is now used to realize the privacy layer 3 indicated here.

Vehicle sensors installed in and on the respective vehicle 11, 12, 13, 14 in the vehicle fleet 10 continuously determine vehicle sensor values, which contain both the status of the vehicle 11, 12, 13, 14, for example its position, its speed, distance driven, route information, as well as information about the age, wear and tear, pending service intervals or the like. Furthermore, the sensors can also be used to determine the status of a person driving the vehicle 11, 12, 13, 14 or passengers, for example by recording the driving style, but also by recording a level of alertness of the person driving the vehicle via an alertness monitoring module. For example, the rate of blinking, and/or other body data are analyzed for this purpose.

Two characteristic vectors are now determined for each of the vehicles 11, 12, 13, 14. These represent the variables of the invention described here by way of example and are at least indirectly dependent on the sensor values, and could also in principle be replaced by a set of the sensor values. In the following exemplary embodiment, however, it is essentially these vectors that are considered as the variables.

For each vehicle in the fleet, therefore, two vectors are determined, a characteristic static n-dimensional value WK, which is determined from the recorded vehicle sensor values and which is approximately constant over time. For example, this can be load collective data. A second vector is determined as a dynamic m-dimensional value WZ from the current vehicle sensor values, for example the position, the speed, the acceleration, and the like. It will change continuously over time.

Particularly the first vector WK now enables identification of the respective vehicle 11, 12, 13, 14 in the vehicle fleet 10, since this value is based on individual vehicle data and the use behavior of a user of the vehicle. It will change very little over time, meaning that it is particularly worthy of protection from a data protection perspective. The second vector WZ, by contrast, reflects up-to-date values of the vehicle 11, 12, 13, 14 and the use thereof. Identifying the vehicle 11, 12, 13, 14 via this value is only indirectly possible, for example by combining position data with local image information or the like. From a data protection point of view, it is therefore somewhat less worthy of protection than the first vector.

These two vectors WK, WZ can now preferably be processed by means of a spatial dimension reduction, e.g., by suitable transformations, such PCA, a deep neural network or the like. WK_n with n dimensions therefore becomes the space WK″ with n′ dimensions. Here, n′<=n. Therefore, the space WK with n dimensions is transformed into a space WK′ with n′ dimensions and is thus compressed and encrypted in a certain way. A similar procedure can then be used for WZ.

It is especially possible to determine vehicles 11, 12, 13, 14 of similar sensor values in WK′ and/or WZ′ space. One specific exemplary embodiment uses machine learning clustering mechanisms (e.g., k-means, mean shift or expectation maximization (EM) clustering) to generate a similarity measure for in WK and/or WZ space. Here, similarities in the WZ or WZ′ space are determined continuously, since these values in the fleet 10 change over time.

The illustration in FIG. 2 accordingly shows an exemplary two-dimensional WK representation of similar and dissimilar vehicle information. The similar vehicle information is symbolized by the dashed border with the cross. These similarities are determined using the described clustering mechanisms. They are based here purely by way of example on a two-dimensional first vector WK and can of course be shown in the same way for the corresponding second vector WZ. The number of dimensions can be much higher than the two dimensions shown here, but these are particularly suitable for the graphic illustration.

In the illustration the FIG. 3, the one-dimensional compression of the illustration in FIG. 2 can correspondingly be seen. The spatial dimension reduction or transformation WK′ is therefore correspondingly shown here. Here as well, the similar vehicles 11, 12, 13, 14 or vehicle information are again shown between the dashed lines and marked with a cross, while the vehicle data lying outside of these dashed lines, i.e., to the right and left of them, are the dissimilar vehicle data and have no additional marking.

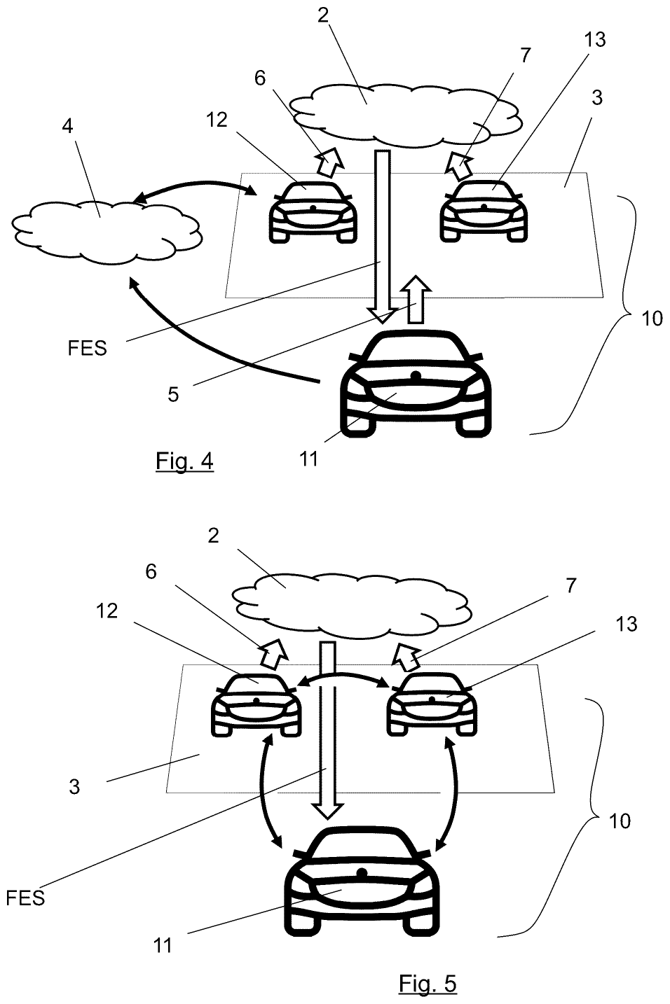

In a first variant according to the illustration in FIG. 4, information can be exchanged from and about vehicles 11,12,13,14 in the fleet 10 via a data center/cloud 4 and the information can be aggregated and analyzed in the data center/cloud 4. This central data center 4 represents a trustworthy entity. This may be e.g., a backend server of the vehicle manufacturer.

When the vehicle-external services FES are called up by the first vehicle 11, instead of the vehicle's information 5, the vehicle information 6 relevant to this service is transmitted from the WK or WZ of similar vehicles 12, or information 6 ascertained from the WK or WZ thereof (e.g., by averaging). If the vehicle information 5 of the vehicle 11 is irrelevant to the service, the vehicle information 7 from the WK and WZ of dissimilar vehicles 13 or random values is or are transmitted instead of the vehicle's own information 5. The privacy layer is thus achieved, which replaces the information 5 of the vehicle 11 with information 6 relevant to the FES from similar vehicles 12 and irrelevant information 7 from dissimilar vehicles 13 and thus conceals the actual information 5 of the vehicle.

To refine the artificial generation of random WZ, generative machine learning methods (e.g., adversarial networks, decoder-encoder networks) can be used. For this, models are trained that are optimized to generate target vectors that are as “realistic” as possible, which can then be used for random WZ values. This “realism” is achieved by using suitable functions, which are defined either generically or depending on the services that the vehicle driver would like to use. It is therefore also possible to focus on the content of the m dimensions.

In a further embodiment, the FES could only be allowed to access the WK′ or WZ′ space and the transformation rule. As a result, user-specific values of WK cannot be reproduced without any further knowledge, since the information in WK′ is compressed (cf. FIG. 3) and a non-invertible transformation is used. It is important here for the dimensional reduction of the spaces WK or WZ to WK′ or WZ′, respectively, to combine the information from a plurality of vehicles 11, 12, 13, 14 in order to achieve sufficiently good compression and to identify similar vehicles 11, 12 in this space and thus guarantee anonymity.

As an alternative, or in addition, information 5 can be aggregated and analyzed in a decentralized manner in the vehicle fleet 10 by way of information exchange between the vehicles 11, 12, 13 in the fleet. This is shown in FIG. 5 analogously to the illustration in FIG. 4. While the first solution reduces data transfer times and latencies, decentral information processing can increase data security (since no central location stores all of the information of the fleet 10) and is robust against the failure of individual nodes, in particular the central node.

In the following, the vehicle fleet 10 is used to test the FES to determine which information is relevant for the results of the service. For this purpose, a plurality of orchestrated queries with values WK and WZ and which cover the possible value range of the query are sent to the provider or the cloud 2. The responses to the queries transmitted by the FES are analyzed in the data center/cloud 4 and/or in the fleet 10 for similarity. For this purpose, firstly, a group of vehicles 11, 12, 13, 14 from the fleet 10 sends queries to the FES, which have similar values in one of the two value ranges (WK or WZ) but different values in the respective other value range. It is thus possible to determine whether values from one category alone are sufficient to use the FES. Building on this, individual values or value groups from WK and WZ are logged and the remaining values are randomized during the query in order to arrive at a final group of vehicle information relevant to using the FES. It is therefore also possible to utilize value ranges that are as far away as possible from WK.

In an application example of a weather app provided by a FES, the information relevant to the FES application is determined by the orchestrated fleet query. In this case, the position data and the target address stored in the navigation system and the arrival time predicted by the navigation system are recognized as relevant information. If a first vehicle 11 now uses the weather app, rather than the position data of the first vehicle 11 being transmitted, it is the position data of a second vehicle 12 from the class with similar position data or generated position data from the averaging of vehicles 12 from the class with similar position data that is transmitted. Similarly, it is not the target address of the first vehicle 11, but the target address of a third vehicle 12 from the class with a similar target address or a target address averaged over a number of similar third vehicles 13 that is transmitted to the weather app. Similarly, the arrival time at the destination of a fourth vehicle 12 with a similar arrival time or averaged arrival times of a class of similar vehicles 12 is used. For the data irrelevant to the use of the FES, precisely that data from other vehicles 13 (or data averaged from these) in the class that has no similarity with the first values of the first vehicle 11 can be used.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-13. (canceled)

14. A method for anonymizing vehicle data for using vehicle-external services, the method comprising:
recording, for each vehicle within a fleet of vehicles of a same type with a diverse group of vehicle users, a first variable, which is at least indirectly dependent on an integer number n of recorded vehicle sensor values, and a second variable, which is at least indirectly dependent on an integer number m of current vehicle sensor values;
determining similarities for at least one of the first and second variables of several or all of the vehicles in the fleet;
categorizing, after determining the similarities, the vehicles into a class that is similar in terms of similarity of the at least one of the first and second variables or into a dissimilar class,
wherein when a vehicle-external service is requested, instead of a variable of the requesting vehicle containing information relevant to the vehicle-external service, at least one of the following is transmitted
a variable, corresponding to the variable of the requesting vehicle, of a vehicle from the class of the similar vehicles,
a computed variable from variables of several vehicles, corresponding to the variable of the requesting vehicle, from the class of the similar vehicles, or
an artificially generated variable similar to the variable of the requesting vehicle.

15. The method of claim 14, wherein when the vehicle-external service requires further information that less relevant for performing the service and the further information is based on the respective other variable, instead of the respective other variable of the requesting vehicle, at least one of the following is transmitted:
the variable, corresponding to the variable of the requesting vehicle, of the vehicle from the class of the dissimilar vehicles,
a computed variable from the variables, corresponding to the variable of the requesting vehicle, of the several vehicles from the class of the dissimilar vehicles, or
an artificially generated variable similar to the variable of the requesting vehicle.

16. The method of 14, wherein the artificially generated variable is a random variable generated via generative machine learning methods.

17. The method of claim 14, wherein each of the first and second variables is formed as a set of the n or m vehicle sensor values.

18. The method of claim 14, wherein each of the first and second variables is formed in a n- or m-dimensional space as a vector based on respective vehicle sensor values.

19. The method of claim 18, wherein the first or second variable is formed as a transformation of the respective vector to a value with a smaller number or at most the same number of dimensions.

20. The method of claim 14, wherein machine learning clustering mechanisms are used to determine the classes of similar and dissimilar variables in order to determine a similarity measure, wherein the first and second variables are classified based on a default value and a comparison of the determined similarity measure with the default value.

21. The method of claim 20, wherein the default value is parameterized or the default value is defined as a function of the relevant vehicle sensor value, the absolute value of the relevant vehicle sensor value, or as a function of the vehicle-external service.

22. The method of claim 14, wherein the first and second variables are at least partially exchanged between the vehicles and a central data center, wherein the first and second variables are aggregated and analyzed by the central data center.

23. The method of claim 14, wherein the first and second variables are at least partially exchanged, aggregated, and analyzed between the vehicles in the fleet.

24. The method of claim 14, wherein, to distinguish between information that is relevant and information that is less relevant to the vehicle-external service, information with a similar first variable and information with a respectively dissimilar second variable is sent from at least some of the vehicles in the fleet to the vehicle-external service, after which the service is then analyzed.

25. The method of claim 24, wherein individual vehicle sensor values are then logged and other vehicle sensor values are randomized to determine relevant and less relevant vehicle sensor values for the use of the respective vehicle-external service.

26. A vehicle comprising:
a plurality of sensors; and
at least one communication interface,
wherein the vehicle is configured, along with other vehicles in a fleet of vehicle or an external data center, to
record, for each of the vehicles within the fleet of vehicles of a same type with a diverse group of vehicle users, a first variable, which is at least indirectly dependent on an integer number n of recorded vehicle sensor values, and a second variable, which is at least indirectly dependent on an integer number m of current vehicle sensor values;
determine similarities for at least one of the first and second variables of several or all of the vehicles in the fleet;
categorize, after determining the similarities, the vehicles into a class that is similar in terms of similarity of the at least one of the first and second variables or into a dissimilar class,
wherein when a vehicle-external service is requested, instead of a variable of the requesting vehicle containing information relevant to the vehicle-external service, at least one of the following is transmitted
a variable, corresponding to the variable of the requesting vehicle, of a vehicle from the class of the similar vehicles,
a computed variable from variables of several vehicles, corresponding to the variable of the requesting vehicle, from the class of the similar vehicles, or
an artificially generated variable similar to the variable of the requesting vehicle.
